(19) United States
(12) Patent Application Publication
(10) Pub. No.: US 2015/0141539 A1
(43) Pub. Date: May 21, 2015

(54) SPONGY COMPOSITION FOR SHOE SOLE

(71) Applicant: FINE CHEMICAL CO., LTD., Gimhae-si, Gyeongsangnam-do (KR)

(72) Inventor: Sung Yull Lee, Busan (KR)

(21) Appl. No.: 14/411,100

(22) PCT Filed: Jun. 24, 2013
(86) PCT No.: PCT/KR2013/005521

§ 371 Date: Dec. 24, 2014

(30) Foreign Application Priority Data
Jun. 25, 2012 (KR) 10-2012-0068183

(51) Int. Cl. C08L 23/08; B29D 35/12; B29D 35/00

(52) U.S. Cl. CPC C08L 23/0853; B29D 35/0009; B29D 35/122; B29K 2023/083
USPC 521/140; 521/134; 264/54

(57) ABSTRACT

Disclosed is a sponge composition for a shoe sole. The sponge composition includes an ethylene copolymer as a matrix, a crosslinking agent, a foaming agent, and a polyvinyl acetate as an adhesion improver. The sponge includes 100 parts by weight of a matrix including an ethylene copolymer, 0.02 to 1.5 parts by weight of a crosslinking agent, 1 to 6 parts by weight of a foaming agent, and 2 to 40 parts by weight of a polyvinyl acetate.

### TECHNICAL FIELD

The present disclosure relates generally to a sponge composition for a shoe sole, and more specifically to a sponge composition for a shoe sole that has improved adhesive properties.

### BACKGROUND ART

Shoe soles have been traditionally made of natural and synthetic rubbers. Since sports shoes have been popularized around the 1980's, the use of sponge soles has been steadily on the rise to keep pace with an increased demand for lightweight sports shoes. Many materials for sponge soles are known, such as polyurethane and ethylene vinyl acetate (EVA). Particularly, EVA sponges account for the largest portion of the sponge sole materials. EVA sponges are formed into midsoles, outsoles, and unitsoles by suitable processes such as press foaming and injection foaming. However, a fatal defect of EVA sponges is insufficient adhesiveness when used in shoes.

Polyurethane-based adhesives are used for the adhesion of EVA sponge shoe parts, such as including midsoles, unitsoles, and outsoles. The adhesion of the shoe parts is performed by the following procedure. First, the surface of an EVA sponge is washed with a solvent and a UV primer is applied thereto. The UV primer is a polar surface modifier. The surface-treated EVA sponge is passed through a UV line. The UV line is a closed line where UV light from a UV lamp is irradiated. Next, the UV-treated sponge is again coated with a primer, passed through a drying line, spread with a polyurethane-based adhesive, passed through a drying line, bonded to an adherend, pressurized in a press, and withdrawn from the press. This procedure is very time-consuming. Particularly, the UV primer is expensive and causes fatal damage to a worker upon contact with the worker's skin, particularly eyes, during drying. Many efforts to solve such problems have been made. For example, Korean Patent Registration No. 328700 discloses a method for producing a shoe sole which includes modifying the surfaces of a midsole and an outsole with plasma and bonding the surface-modified sole parts to each other. This plasma modification is effective in enhancing the adhesive strength of the shoe sole and eliminates the need to use an organic solvent. According to the method, a low-temperature plasma system is used to modify the surface of the midsole instead of UV treatment. Accordingly, the method is merely another complex one that replaces conventional methods

### DETAILED DESCRIPTION OF THE INVENTION

### Technical Solution

According to one aspect of the present disclosure, a sponge composition for a shoe sole is provided which includes an ethylene copolymer as a matrix, a crosslinking agent, a foaming agent, and a polyvinyl acetate as an adhesion improver.

According to a further aspect of the present disclosure, a sponge composition for a shoe sole is provided which includes 100 parts by weight of a matrix including an ethylene copolymer, 0.02 to 1.5 parts by weight of a crosslinking agent, 1 to 6 parts by weight of a foaming agent, and 2 to 40 parts by weight of a polyvinyl acetate.

According to another aspect of the present disclosure, there is provided a shoe sole produced by pressing or injection molding of any one of the sponge compositions.

### Mode for Carrying out the Invention

The present disclosure will now be described in more detail.

The present disclosure provides a sponge composition for a shoe sole including an ethylene copolymer or a blend of an ethylene copolymer and a synthetic rubber as a matrix, a crosslinking agent, a foaming agent, and a polyvinyl acetate as an adhesion improver.

The crosslinking agent and the foaming agent are additives for foam processing. The sponge composition of the present disclosure may further include one or more additives selected from fillers, pigments, and other additives. The composition of the present disclosure is produced in the form of sheets or pellets, which are then molded under heat (150 to 250° C.) and pressure (100 to 300 kg/cm²) to produce shoe soles.

The ethylene copolymer may be a copolymer of i) ethylene and ii) at least one ethylenically unsaturated monomer selected from the group consisting of C₃-C₁₀ α-monoolefins, C₁-C₁₂ alkyl esters of unsaturated C₃-C₂₀ monocarboxylic acids, unsaturated C₃-C₂₀ mono- or dicarboxylic acids, anhydrides of unsaturated C₄-C₈ dicarboxylic acids, and vinyl esters of saturated C₂-C₁₈ carboxylic acids.

Specifically, the ethylene copolymer may be, for example, selected from the group consisting of ethylene vinyl acetate (EVA), ethylene butyl acrylate (EBA), ethylene methyl acrylate (EMA), ethylene ethyl acrylate (EEA), ethylene methyl methacrylate (EMMA), ethylene butene copolymers (EB-Co), ethylene octene copolymers (EO-Co), and mixtures thereof.

The matrix may further include a synthetic rubber. In other words, the ethylene copolymer may be used alone or may be optionally blended with a synthetic rubber in a weight ratio of 1:0.01 to 1:1. The synthetic rubber may be a styrene butadiene rubber (SBR), a butadiene rubber (BR), an isoprene rubber (IR), a nitrile rubber (NBR), a chloroprene rubber (CR), a chlorosulfonated polyethylene rubber (CSM), an ethylene- propylene rubber (EPM), an ethylene-propylene-diene rubber (EPDM), or a combination thereof. The use of the ethylene copolymer/synthetic rubber blend as the matrix can improve the elasticity of a final shoe sole.

The foaming agent is added to produce a foam. The foaming agent is an azo-based compound having a decomposition temperature of 150 to 210° C. The azo-based compound is preferably used in an amount of 1 to 6 parts by weight, based on 100 parts by weight of the polymer matrix. If the use of the azo-based compound in an amount of less than 1 part by weight may lead to the production of a foam having a specific gravity of 0.7 or more and a Shore C hardness of 70 or more, which are disadvantageous in terms of weight reduction. Meanwhile, the use of the azo-based compound in an amount exceeding 6 parts by weight may lead to the production of a foam having a specific gravity of 0.10 or less, which is advantageous in terms of weight reduction, but may cause poor mechanical properties and dimensional stability of the foam. If the azo-based compound has a decomposition temperature lower than 150° C., early foaming may occur during compounding. Meanwhile, if the azo-based compound has a decomposition temperature higher than 210° C., it may take at least 15 minutes to mold into a foam, resulting in low productivity. The azo-based compound as the foaming agent is typically azodicarbonamide (ADCA). The foaming agent may be any compound whose decomposition temperature is within the range defined above.

The crosslinking agent may be an organic peroxide that sufficiently captures gases generated as a result of decomposition of the foaming agent and can impart high-temperature viscoelasticity to the resin. The organic peroxide is used in an amount of 0.02 to 1.5 parts by weight, preferably 0.05 to 1.0 part by weight, based on 100 parts by weight of the matrix. The organic peroxide has a 1 minute half-life temperature of 130 to 180° C. The use of the organic peroxide in an amount of less than 0.02 parts by weight may lead to insufficient crosslinking, making it difficult to maintain high- temperature viscoelasticity of the resin. Meanwhile, the use of the organic peroxide in an amount exceeding 1.5 parts by weight may lead to excessive crosslinking, resulting in a dramatic increase in hardness and the rupture of a foam. Examples of such crosslinking agents include those commonly used in rubber compounding, such as t-butyl peroxy isopropyl carbonate, t-butyl peroxy laurylate, t-butyl peroxy acetate, di-t-butyl peroxy phthalate, t-dibutyl peroxy maleic acid, cyclohexanone peroxide, t-butyl cumyl peroxide, t-butyl hydroperoxide, t-butyl peroxy benzoate, dicumyl peroxide, 1,3-bis(t-butylperoxyisopropyl)benzene, methyl ethyl ketone peroxide, 2,5-dimethyl-2,5-di(benzoyloxy)hexane, 2,5-dimethyl-2,5-di(t-butylperoxy)hexane, di-t-butyl peroxide, 2,5-dimethyl-2,5-(t-butylperoxy)-3-hexane, n-butyl-4,4-bis(t-butylperoxy)valerate, and α,α′-bis(t-butylperoxy)diisopropylbenzene.

The other additives are those that are commonly used in the production of shoe soles to assist in improving the processing properties of the shoe soles and to improve the physical properties of the shoe soles. Examples of the additives include metal oxides, stearic acid, antioxidants, zinc stearate, titanium dioxide, and co-crosslinking agents. Various pigments may also be used in consideration of desired colors. The additives may be added in a total amount of 4 to 15 parts by weight, based on 100 parts by weight of the matrix. The metal oxide can be used to improve the physical properties of a foam, and examples thereof include zinc oxide, titanium oxide, cadmium oxide, magnesium oxide, mercury oxide, tin oxide, lead oxide, and calcium oxide. The metal oxide may be used in an amount of 1 to 4 parts by weight, based on 100 parts by weight of the matrix. Triallyl cyanurate (TAC) as the co-crosslinking agent is preferably used in an amount of 0.05 to 0.5 parts by weight, based on 100 parts by weight of the matrix. Trially cyanurate is used to adjust the molding time of the composition to 5 to 10 minutes when the temperature of a press is from 150 to 170° C. If the co-crosslinking agent is used in an amount of less than 0.05 parts by weight, its effect is negligible. Meanwhile, if the co-crosslinking agent is used in an amount exceeding 0.5 parts by weight, the composition is excessively crosslinked, resulting in the rupture of a foam, similarly to when the crosslinking agent is used in an amount exceeding 1.5 parts by weight.

Stearic acid and zinc stearate induce the formation of fine and uniform foamed cells and facilitate demolding after molding. Stearic acid and zinc stearate each is typically used in an amount of 1 to 4 parts by weight, based on 100 parts by weight of the matrix. Examples of the antioxidants include Sonnoc, butylated hydroxy toluene (BHT), and Songnox 1076 (octadecyl 3,5-di-tert-butyl hydroxyhydrocinnamate). The antioxidant is typically used in an amount of 0.25 to 2 parts by weight, based on 100 parts by weight of the matrix. Titanium dioxide is used as a white pigment and performs the same functions as the above-mentioned metal oxides. Titanium dioxide is typically used in an amount of 2 to 5 parts by weight.

The use of the filler in the composition contributes to cost reduction of the composition. Examples of suitable fillers include silica (SiO₂), MgCO₃, CaCO₃, talc, Al(OH)₃, and Mg(OH)₂. The filler is typically used in an amount of 10 to 50 parts by weight, based on 100 parts by weight of the matrix.

The presence of the polyvinyl acetate (PVAc) in the sponge composition of the present disclosure enables the production of a shoe sole with greatly improved adhesion to an adherend.

The polyvinyl acetate is a thermoplastic resin prepared by polymerization a vinyl acetate monomer. The polyvinyl acetate may adhere to wood or paper. The acetic acid groups in the side chains of polyvinyl acetate are readily saponified. As a result of the saponification, the polyvinyl acetate is converted to the corresponding polyvinyl alcohol. The characteristics of the polyvinyl acetate vary depending on the degree of saponification. According to one embodiment of the present disclosure, the polyvinyl acetate is a homopolymer having a weight average molecular weight of 500 to 300,000, preferably 1,000 to 200,000, more preferably 5,000 to 100,000. If the molecular weight of the polyvinyl acetate is less than the lower limit defined above, poor physical properties of the composition may be caused. Meanwhile, if the molecular weight of the polyvinyl acetate exceeds the upper limit defined above, the processability of the composition may deteriorate. The polyvinyl acetate may be present in an amount of 2 to 40 parts by weight, preferably 5 to 30 parts by weight, more preferably 5 to 15 parts by weight, based on 100 parts by weight of the matrix. The presence of the polyvinyl acetate in an amount of less than 2 parts by weight may lead to little improvement in adhesive properties. Meanwhile, the presence of the polyvinyl acetate in an amount exceeding 40 parts by weight may cause the sponge composition to be stuck to a processing machine such as a kneader or a roll mill, and as a result, the workability of the composition may deteriorate during mixing and sheeting, making it difficult to produce a sponge. Particularly, when the content of the polyvinyl acetate is higher than 5 parts by weight, a rubber sole is not separated from a midsole at the interface but ‘material destruction’ of the midsole occurs even without UV treatment, which was confirmed in an adhesion test. The occurrence of material destruction indicates good adhesive properties of the composition.

The polyvinyl acetate may be mixed with the matrix in a closed mixer (e.g., a Banbury mixer or a kneader) or an open mixer (e.g., a roll mill).

The sponge composition of the present disclosure can be crosslinked to produce a sponge by the following procedure.

First, a blend of the ethylene copolymer and the synthetic rubber, together with the polyvinyl acetate, is mixed with the crosslinking agent, the foaming agent, and other additives in a mixer.

Next, the mixture is heated to 140 to 200° C., followed by molding to obtain a sponge for a shoe sole.

Specifically, the molding can be performed by two processes: pressing and injection molding processes. According to the pressing process, the mixture is pressurized in a mold of a press under predetermined temperature, pressure, and time conditions to obtain a plate-like sponge. Then, the sponge is subjected to skived, cut, and ground into a preform with desired thickness and shape. Subsequently, the preform is molded in a mold under heat and pressure and is then pressurized during cooling in a closed state of the mold (this process is called “phylon molding” in the shoe industry) to produce a final shoe sole.

According to the injection molding process, the mixture is pelletized using suitable equipment such as an extruder. The pellets are injected into a mold of a foaming injection molding machine and are foamed under predetermined temperature and pressure conditions to produce a final foam. At this time, the mold is designed to have a smaller size by a foaming magnitude of the mixture than the final product. After foaming, the mixture is expanded to the desired size of the product.

The sponge sole produced by the present disclosure has improved adhesive properties. The EVA-based sponge can be adhered to an adherend even without the need for UV processing. Sponges based on polyolefin elastomers (POEs) such as ethylene octene copolymers (EOCs) and ethylene butene copolymers (EBCs) lack the ability to adhere to adherends even after UV processing due to their non-polar materials. This impedes the use of the POE-based sponges in shoes. According to the present disclosure, the use of the polyvinyl acetate, together with UV processing, allows a POE-based sponge to have an adhesive strength sufficient to be used in a shoe. During molding, the polyvinyl acetate is dispersed in the polymer matrix and is co-crosslinked with the organic peroxide, resulting in an increase in the crosslinking density of the polymer. At the same time, the polyvinyl acetate renders the polymer mixture polar as a whole. It can be concluded that this increased polarity of the polymer contributes to an improvement in the adhesive strength of a shoe sole.

The present disclosure will be explained in more detail with reference to the following examples.

### EXAMPLES

100 parts by weight of EVA (VA 21%, MI 2.5), 5 parts by weight of ZnO, 1 part by weight of stearic acid, and a polyvinyl acetate were compounded in a kneader. The amount of the polyvinyl acetate is shown in Table 1. Thereafter, the mixture was mixed with 0.8 parts by weight of dicumyl peroxide (DCP) as a crosslinking agent and 2 parts by weight of azodicarbonamide (ADCA) as a foaming agent in an open roll, followed by extrusion to obtain of an expandable composition in the form of pellets. In some examples, POE was used as a matrix resin instead of EVA. The POE resin was an ethylene octene copolymer having a specific gravity of 0.89 (Engage 8003, Dow). The pellets were injection molded in a shoe midsole mold mounted in a foaming injection molding machine. The molding was performed at a press pressure of 150 kg/cm² and a temperature of 170° C. for 400 s. A shoe midsole was taken out of the mold.

The surface of the shoe midsole was washed with toluene and a UV primer (P-5) was applied thereto. The surface-treated shoe midsole was passed through a UV line for UV treatment, coated with a primer (Bond Ace 232H), passed through a drying line, spread with an adhesive (D-Ace 5200), and dried. Separately, a rubber outsole was spread with a primer (D-Ply 007), dried, spread with an adhesive (D-Ace 5200), and dried. In some examples, UV treatment was not performed. All adhesives and primers used were purchased from Henkel.

The shoe midsole was bonded to the rubber outsole. The resulting structure was pressed in a press to obtain a specimen. An adhesion test was conducted for the specimen. First, the specimen was cut to a width of 2 cm. The strength required to peel the rubber outsole from the midsole at the interface therebetween was measured using a tensile strength tester. The measured strength was expressed in kg/cm. The test results are shown in Table 1. Unless otherwise specified, the numbers corresponding to the respective raw materials in Table 1 are parts by weight.

TABLE 1
Adhesion test results

| | Comparative | | | | | Comparative | |
|---|---|---|---|---|---|---|---|
| | Example 1 | Example 1 | Example 2 | Example 3 | Example 4 | Example 2 | Example 5 |
| EVA (VA21%) | 100 | 100 | 100 | 100 | 100 | | |
| POE (Density 0.89) | | | | | | 100 | 100 |
| ZnO | 5 | 5 | 5 | 5 | 5 | 5 | 5 |
| Stearic acid | 1 | 1 | 1 | 1 | 1 | 1 | 1 |
| DCP | 0.8 | 0.8 | 0.8 | 0.8 | 0.8 | 0.8 | 0.8 |
| ADCA | 2 | 2 | 2 | 2 | 2 | 2 | 2 |
| Polyvinyl acetate | — | 1 | 10 | 40 | 50 | — | 20 |
| Expansion Ratio | 160 | 160 | 160 | 140 | 110 | 160 | 160 |
| (linear expansion, %) | | | | | | | |
| Hardness (Shore C) | 55 | 55 | 56 | 65 | 90 | 56 | 58 |
| Tensile strength | 25 | 25 | 25 | 50 | 70 | 27 | 27 |
| (kg/cm²) | | | | | | | |
| Elongation (%) | 300 | 300 | 280 | 200 | 50 | 300 | 250 |
| | | | | | Stuck to | | |
| | | | | | processing | | |
| | | | | | machine, Nearly | | |
| | | | | | impossible to | | |
| | | | | | process | | |
| Adhesive strength to | | | | | | | |
| rubber outsole | | | | | | | |
| UV treatment | Material | Material | Material | Material | Material | Surface peel | Material |
| | destruction | destruction | destruction | destruction | destruction | strength 0.5 | destruction |
| | | | | | | kg/cm | |
| Without UV treatment | Surface peel | Surface peel | Material | Material | Material | Surface peel | Surface peel |
| | strength 1.0 | strength 1.5 | destruction | destruction | destruction | strength 0.2 | strength 1.0 |
| | kg/cm | kg/cm | | | | kg/cm | kg/cm |
| Applicability to shoe | Possible | Possible | Possible | Possible | Impossible | Impossible | Possible |
| after UV treatment | | | | | | | |
| Applicability to shoe | Impossible | Impossible | Possible | Possible | Impossible | Impossible | Impossible |
| without UV treatment | | | | | | | |

The ‘material destruction’ in Table 1 means that the rubber sole and the shoe midsole were not separated from each other at the interface therebetween but the shoe midsole (sponge) was destroyed. The occurrence of material destruction indicates high adhesive strength. Particularly, when the surface peel strength of the specimen was at least 3.0 kg/cm, the corresponding composition was judged to be applicable to a shoe and was expressed as ‘possible’.

The sponges of Comparative Examples 1 and 2, which did not use the polyvinyl acetate and were not treated with UV, had low surface peel strengths. Particularly, the sole sponge of Comparative Example 2 using the non-polar matrix (POE) had very low surface peel strengths irrespective of UV treatment. In contrast, ‘material destruction’ occurred in the sponges of Examples 1-5, each of which used the polyvinyl acetate and was treated with UV, indicating high adhesive strengths of the sponges. Exceptionally, the sponge of Example 4 using an excessively large amount of the polyvinyl acetate was stuck to the processing machine, thus being unsuitable for the mass production of shoes.

Surface peeling was observed in the sponges of Examples 1 and 5 without treatment with UV, but the sponges of Examples 1 and 5 showed higher adhesive strengths than the sponges of Comparative Examples 1 and 2.

These results demonstrate that the polyvinyl acetate is effective in improving the adhesion performance of the sponges. Therefore, UV treatment for the adhesion of the shoe soles can be omitted depending on processing conditions (for example, Examples 2 and 3). This is advantageous because expensive UV primers do not need to be used and workers are protected from exposure to UV light.

1. A sponge composition for a shoe sole, comprising an ethylene copolymer as a matrix, a crosslinking agent, a foaming agent, and a polyvinyl acetate as an adhesion improver.

2. The sponge composition according to claim 1, wherein the matrix further comprises a synthetic rubber.

3. The sponge composition according to claim 1, wherein the polyvinyl acetate is present in an amount of 2 to 40 parts by weight, based on 100 parts by weight of the matrix.

4. The sponge composition according to claim 2, wherein the matrix is a blend of the ethylene copolymer and the synthetic rubber in a weight ratio of 1:0.01 to 1:1.

5. The sponge composition according to claim 1, wherein the ethylene copolymer is a copolymer of i) ethylene and ii) at least one ethylenically unsaturated monomer selected from the group consisting of C3-C10 α-monoolefins, C1-C12 alkyl esters of unsaturated C3-C20 monocarboxylic acids, unsaturated C3-C20 mono- or dicarboxylic acids, anhydrides of unsaturated C4-C8 dicarboxylic acids, and vinyl esters of saturated C2-C18 carboxylic acids.

6. The sponge composition according to claim 2, wherein the synthetic rubber is selected from the group consisting of styrene butadiene rubber (SBR), butadiene rubber (BR), isoprene rubber (IR), nitrile rubber (NBR), chloroprene rubber (CR), chlorosulfonated polyethylene rubber (CSM), ethylene-propylene rubber (EPM), ethylene-propylene-diene rubber (EPDM), and combinations thereof.

7. The sponge composition according to claim 1, wherein the polyvinyl acetate has a weight average molecular weight of 500 to 300,000.

8. A sponge composition for a shoe sole, comprising 100 parts by weight of a matrix comprising an ethylene copolymer, 0.02 to 1.5 parts by weight of a crosslinking agent, 1 to 6 parts by weight of a foaming agent, and 2 to 40 parts by weight of a polyvinyl acetate.

9. The sponge composition according to claim 8, wherein the ethylene copolymer is selected from the group consisting of ethylene vinyl acetate (EVA), ethylene butyl acrylate (EBA), ethylene methyl acrylate (EMA), ethylene ethyl acrylate (EEA), ethylene methyl methacrylate (EMMA), ethylene butene copolymers (EB-Co), ethylene octene copolymers (EO-Co), and mixtures thereof.

10. The sponge composition according to claim 8, wherein the matrix further comprises a synthetic rubber.

11. A shoe sole produced by pressing or injection molding of the sponge composition according to claim 1.

12. A shoe sole produced by pressing or injection molding of the sponge composition according to claim 8.
